(19) United States
(12) Patent Application Publication
(10) Pub. No.: US 2013/0292502 A1
(43) Pub. Date: Nov. 7, 2013

(54) PAPER SHREDDER WITHOUT WASTEBASKET

(71) Applicant: Guofeng PAN, Dongguan City (CN)

(72) Inventor: Guofeng PAN, Dongguan City (CN)

(21) Appl. No.: 13/461,867

(22) Filed: May 2, 2012

(51) Int. Cl. B02C 23/02

(52) U.S. Cl. 241/285.1

(57) ABSTRACT

This invention relates to a paper shredder without wastebasket. The bottom of the cutting head is connected with a scrap discharge unit, including a housing, a rotating screw and a driving mechanism, wherein at the upper end of the housing is disposed with a scrap collecting groove, on one side of the housing is disposed with a scrap outlet, the rotating screw for discharging scraps out of the housing is disposed within the housing chamber and one end of the rotating screw is connected with the driving mechanism. When the paper shredder is in operation, the driving mechanism drives the rotating screw to rotate so as to deliver paper scraps to the scrap outlet to complete discharging.

### TECHNICAL FIELD OF THE INVENTION

This invention pertains to the category of the paper shredder technology, more particularly, the invention relates to a paper shredder without wastebasket.

### BACKGROUND OF THE INVENTION

A conventional paper shredder includes a cutting head and a wastebasket, in which the cutting head is configured above the wastebasket. On one hand, as the wastebasket acts as one of the essential components of shredders to collect the paper scraps falling off the paper exit that is disposed on the cutting head, it occupies a relatively large space of the paper shredder. Furthermore, in the process of shredding, it is highly inconvenient for users to clear up the wastebasket on a regular basis. On the other hand, the cutter shaft set at the bottom of the cutting head is uncovered at the paper exit, there is a potential safety hazards that users may get hurt while clearing up the wastebasket.

### SUMMARY OF THE INVENTION

In view of abovementioned problems, it is one object of the invention to overcome the drawbacks of the prior art by providing a safe and reliable paper shredder without wastebasket.

To achieve aforesaid object, the adopted technical solution is described below:

A paper shredder without wastebasket, in accordance with this invention, comprises a cutting head, having a paper exit disposed at the bottom thereof. The bottom of the cutting head is connected with a scrap discharge unit, which includes a housing, a rotating screw and a driving mechanism. At the upper end of the housing is disposed with a scrap collecting groove, on one side of the housing is disposed with a scrap outlet, a rotating screw for discharging paper scraps out of the housing is disposed within the housing chamber and one end of the rotating screw is connected with the driving mechanism.

Specifically, the driving mechanism is one-way transmission gears, which are fixed on a rotating shaft that is disposed at one end of the rotating screw.

More specifically, the one-way transmission gears are connected with a drive motor or drive gears that are disposed within the cutting head to drive a cutter shaft set.

Advantages of this invention are described as follows:

In accordance with the present invention, the bottom of the cutting head is connected with a scrap discharge unit, which includes a housing, a rotating screw and a driving mechanism, wherein at the upper end of the housing is disposed with a scrap collecting groove, on one side of the housing is disposed with a scrap outlet, a rotating screw for discharging scraps out of the housing is disposed within the housing chamber and one end of the rotating screw is connected with the driving mechanism. When the paper shredder provided in the invention is in operation, the driving mechanism drives the rotating screw to rotate so as to deliver paper scraps to the scrap outlet to complete discharging. The scrap discharge unit provided herein enables the paper shredder to be used without wastebasket, and meanwhile the paper exit is covered by the scrap discharge unit, therefore the safety is largely improved.

### BRIEF DESCRIPTION OF THE DRAWINGS

FIG. 1 is a structural representation of a paper shredder without wastebasket in accordance with the present invention;

FIG. 2 is a partial sectional view of the paper shredder without wastebasket in accordance with the present invention; and

FIG. 3 is a structural representation of the paper shredder without wastebasket in accordance with the present invention without the housing of both the cutting head and the scrap discharge unit.

### DETAILED DESCRIPTION OF THE EMBODIMENTS

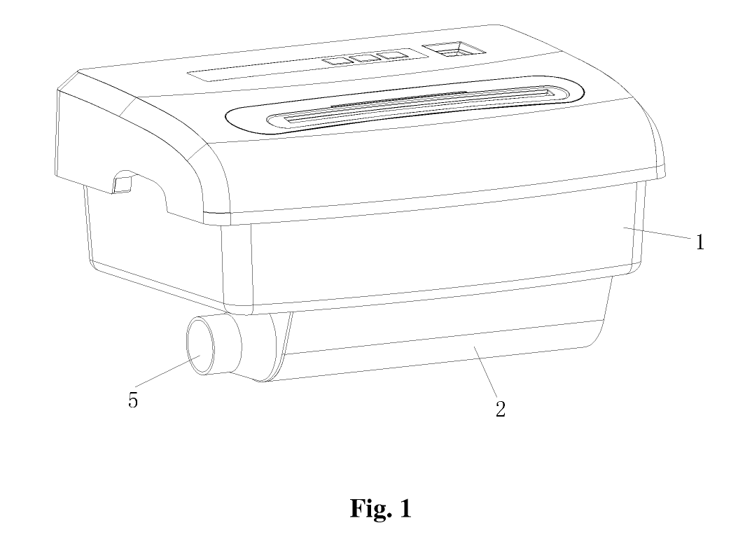

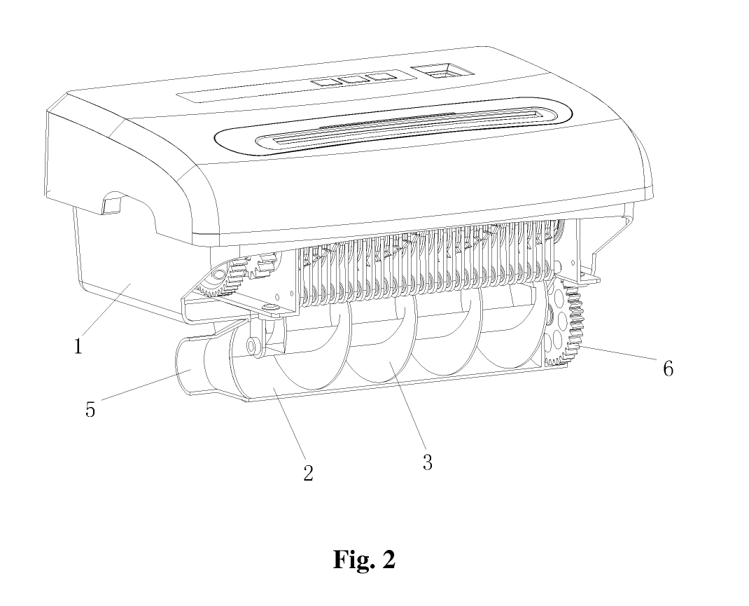

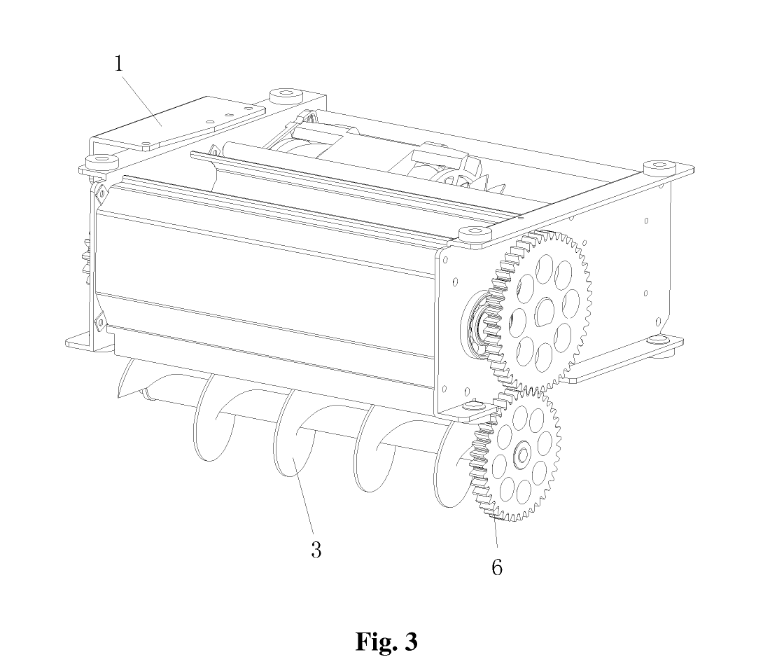

As shown in FIGS. 1-3, a paper shredder without wastebasket provided by the invention comprising a cutting head 1, having a paper exit disposed at the bottom thereof. The bottom of the cutting head 1 is connected with a scrap discharge unit, which includes a housing 2, a rotating screw 3 and a driving mechanism, in which at the upper end of the housing 2 is disposed with a scrap collecting groove, on one side of the housing 2 is disposed with a scrap outlet 5, a rotating screw 3 for discharging scraps out of the housing 2 is disposed within the chamber of the housing 2 and one end of the rotating screw 3 is connected with the driving mechanism.

In accordance with a preferred embodiment, the driving mechanism is one-way transmission gears 6, which are fixed on a rotating shaft that is disposed at one end of the rotating screw 3.

Specifically, the one-way transmission gears 6 are connected with a drive motor, which drives the one-way transmission gear 6 to rotate to further drive the rotating screw 3 to rotate so as to discharge paper scraps within the housing 2 out of the scrap outlet 5.

In accordance with the preferred embodiment, the one-way transmission gears 6 are connected to drive gears that are disposed within the cutting head 1 and which are intended to drive the cutter shaft set, specifically, said drive gears drive the one-way transmission gears 6 to rotate to further drive the rotating screw 3 to rotate so as to discharge paper scraps within the housing 2 out of the scrap outlet 5.

When the paper shredder provided in the invention is in operation, papers are firstly shredded into scraps by the cutter shaft set within the cutting head and then the paper scraps fall off from the paper exit. The paper scraps fall on the rotating screw 3 within the housing 2 via the scrap collecting groove. The one-way transmission gears 6 drive the rotating screw 3 to rotate so that paper scraps on the rotating screw 3 can be delivered to the scrap outlet 5 to complete discharging. The scrap discharge unit provided herein enables the paper shredder to be used without wastebasket, and meanwhile the paper exit is covered by the scrap discharge unit, therefore the safety is largely improved.

The foregoing description is only a preferred embodiment of the invention. People who are skilled in the related art can easily produce the alternative embodiments or improvements based on the above detailed description. The present invention is not limited to the above detailed description.

What is claimed is:

1. A paper shredder without wastebasket comprising:
a cutting head,
the bottom of the cutting head is disposed with a paper exit,
wherein the bottom of the cutting head is connected with a scrap discharge unit,
the scrap discharge unit includes a housing, a rotating screw and a driving mechanism,
at the upper end of the housing is disposed with a scrap collecting groove,
on one side of the housing is disposed with a scrap outlet,
the rotating screw for discharging scraps out of the housing is disposed within the housing chamber, and
one end of the rotating screw is connected with the driving mechanism.

2. The paper shredder without wastebasket according to claim 1, wherein said driving mechanism is one-way transmission gears, which are fixed on a rotating shaft that is disposed at one end of the rotating screw.

3. The paper shredder without wastebasket according to claim 2, wherein said one-way transmission gears are connected with a drive motor or drive gears that are disposed within the cutting head to drive a cutter shaft set.
